(19) United States
(12) Patent Application Publication
(10) Pub. No.: US 2009/0315460 A2
(43) Pub. Date: Dec. 24, 2009

(54) PLASMA DISPLAY PANEL

(75) Inventor: Min CHUNG, Seoul (KR)

Correspondence Address: FISH & RICHARDSON P.C., P.O. BOX 1022, MINNEAPOLIS, MN, 55440-1022, UNITED STATES, 202-783-5070, 202-783-2331, PATDOCTC@fr.com

(73) Assignee: LGElectronics Inc., Seoul (KR)

(21) Appl. No.: 11/278,474

(22) Filed: Apr. 3, 2006

(30) Foreign Application Priority Data
May 11, 2005 (KR) 1020050039293

(51) Int. Cl. H01J 17/49

(52) U.S. Cl. 313/582

(57) ABSTRACT

A plasma display panel is provided. The plasma display panel includes a front glass substrate, a transparent electrode formed on the front glass substrate, a black layer formed on an upper part of the transparent electrode, and a bus electrode formed on an upper part of the black layer. The width of the bus electrode is less than the width of the black layer.

This Nonprovisional application claims priority under 35 U.S.C. § 119(a) on Patent Application No. 2005-0039293 filed in Korea on May 11, 2005 the entire contents of which are hereby incorporated by reference.

### BACKGROUND OF THE INVENTION

1. Field of the Invention

This document relates to a display apparatus, and more particularly, to a plasma display apparatus.

2. Description of the Background Art

Out of display apparatuses, a plasma display apparatus generally comprises a plasma display panel and a driver for driving the plasma display panel.

The plasma display panel comprises a front panel and a rear panel which are made of soda-lime glass. Barrier ribs formed between the front panel and the rear panel form discharge cells. Each of the discharge cells is filled with an inert gas such as a He—Xe gas mixture, a He—Ne gas mixture. When the inert gas is discharged by a high frequency voltage, vacuum ultraviolet rays are generated. Vacuum ultraviolet rays excites a phosphors formed between the barrier ribs to display an image on the plasma display panel.

The front panel comprises a transparent electrode and a bus electrode. A black layer is formed between the transparent electrode and the bus electrode. The black layer is formed of an electrically conductive material such as ruthenium oxide, lead oxide, carbon series. The black layer and a black matrix formed between maintenance electrode pairs improve the contrast between the discharge cells.

Since Ag forming the bus electrode does not transmit light generated by the discharge and reflects light generated from the outside of the plasma display panel, the contrast is degraded.

The black layer capable of improving the contrast is interposed between the transparent electrode and the bus electrode to overcome the above-described problem.

The black layer performs a light blocking function for reducing reflectivity by absorbing external light generated from the outside of a front glass substrate of the front panel, and improves color purity and the contrast of the front glass substrate.

However, since the width of the related art black layer is approximately equal to the width of the bus electrode, edge curl is easily generated in an edge of the bus electrode. A poor contact occurs where the bus electrode contacts the black layer. It is difficult to uniformly accumulate wall charges within the discharge cell. Further, the black layer insufficiently performs the light blocking function and insufficiently improves the color purity and the contrast.

### SUMMARY OF THE INVENTION

Accordingly, an object of the present invention is to solve at least the problems and disadvantages of the background art.

Embodiments of the present invention provide a plasma display panel capable of easily uniformly accumulating wall charge by preventing edge curl and improving contrast by reducing black luminance.

The embodiments of the present invention also provide a plasma display panel with improved contrast that can be manufactured in a simplified and less costly manner.

According to an aspect, there is provided a plasma display panel comprising a front glass substrate, a transparent electrode formed on the front glass substrate, a black layer formed on an upper part of the transparent electrode, and a bus electrode of the width less than the width of the black layer formed on an upper part of the black layer.

According to another aspect, there is provided a plasma display panel comprising a front glass substrate, a transparent electrode formed on the front glass substrate, a black layer formed on an upper part of the transparent electrode and a non-discharge region between discharge cells, and a bus electrode of the width less than the width of the black layer formed on an upper part of the black layer on the transparent electrode.

According to still another aspect, there is provided a plasma display panel comprising a front glass substrate, a black layer formed on the front glass substrate, and a bus electrode of the width less than the width of the black layer formed on an upper part of the black layer.

In the plasma display panel according to the embodiments of the present invention, the edge curl is prevented and the wall charges uniformly are accumulated by forming the bus electrode more narrowly than the width of the black layer. Further contrast is improved by reducing black luminance.

The plasma display panel according to the embodiments of the present invention simplifies the manufacturing process and reduces the manufacturing cost.

### BRIEF DESCRIPTION OF THE DRAWINGS

The invention will be described in detail with reference to the following drawings in which like numerals refer to like elements.

FIG. 1 shows a plasma display panel according to a first embodiment of the present invention;

FIG. 2 is a schematic cross-sectional view of a front panel of the plasma display panel according to the first embodiment of the present invention;

FIG. 3 is a flowchart of a method of manufacturing the front panel of the plasma display panel according to the first embodiment of the present invention;

FIG. 4 is a schematic cross-sectional view of a front panel of a plasma display panel according to a second embodiment of the present invention;

FIGS. 5a through 5e are cross-sectional views sequentially illustrating each of stages in a method of manufacturing the front panel of the plasma display panel according to the second embodiment of the present invention; and

FIG. 6 is a schematic cross-sectional view of a front panel of a plasma display panel according to a third embodiment of the present invention.

### DETAILED DESCRIPTION OF PREFERRED EMBODIMENTS

Embodiments of the present invention will be described in a more detailed manner with reference to the drawings.

A plasma display panel according to embodiments of the present invention comprises a front glass substrate, a transparent electrode formed on the front glass substrate, a black layer formed on an upper part of the transparent electrode, and a bus electrode of the width less than the width of the black layer formed on an upper part of the black layer.

It is preferable that the bus electrode is formed in the middle of the black layer.

It is preferable that the width of the black layer ranges from 20 μM to 100 μm.

It is preferable that the width of the black layer ranges from 50 μm to 80 μm.

It is preferable that the width of the bus electrode ranges from 50% to 90% of the width of the black layer.

It is preferable that the difference between the width of the black layer and the width of the bus electrode is less than 20 μm.

A plasma display panel according to the embodiments of the present invention comprises a front glass substrate, a transparent electrode formed on the front glass substrate, a black layer formed on an upper part of the transparent electrode and a non-discharge region between discharge cells, and a bus electrode of the width less than the width of the black layer formed on an upper part of the black layer on the transparent electrode.

It is preferable that the bus electrode is formed in the middle of the black layer on the transparent electrode.

It is preferable that the width of the black layer on the transparent electrode ranges from 20 μm to 100 μm.

It is preferable that the width of the black layer on the transparent electrode ranges from 50 μm to 80 μm.

It is preferable that the width of the bus electrode ranges from 50% to 90% of the width of the black layer on the transparent electrode.

It is preferable that the difference between the width of the black layer on the transparent electrode and the width of the bus electrode is less than 20 μm.

A plasma display panel according to the embodiments of the present invention comprises a front glass substrate, a black layer formed on the front glass substrate, and a bus electrode of the width less than the width of the black layer formed on an upper part of the black layer.

It is preferable that the bus electrode is formed in the middle of the black layer.

It is preferable that the width of the black layer ranges from 20 μm to 100 μm.

It is preferable that the width of the black layer ranges from 50 m to 80 μm.

It is preferable that the width of the bus electrode ranges from 50% to 90% of the width of the black layer.

It is preferable that the difference between the width of the black layer and the width of the bus electrode is less than 20 μm.

Hereinafter, exemplary embodiments of the present invention will be described in detail with reference to the attached drawings.

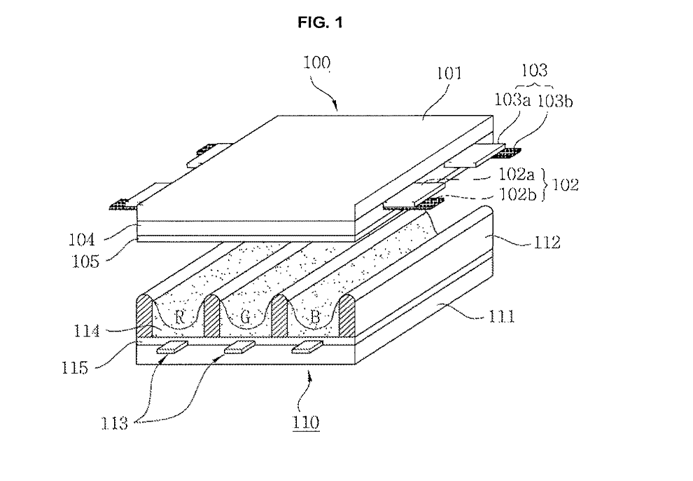

FIG. 1 shows a plasma display panel according to a first embodiment of the present invention.

As shown in FIG. 1, the plasma display panel according to the first embodiment of the present invention comprises a front panel 100 and a rear panel 110 which are coupled in parallel to be opposed to each other at a given distance therebetween.

A plurality of scan electrodes 102 and a plurality of sustain electrodes 103 are formed in pairs on a front glass substrate 101 of the front panel 100 to form a plurality of maintenance electrode pairs.

The scan electrode 102 and the sustain electrode 103 each comprise transparent electrodes 102a and 103a made of transparent indium-tin-oxide (ITO) material and bus electrodes 102b and 103b made of a metal material. The scan electrode 102 and the sustain electrode 103 generate a mutual discharge therebetween in one discharge cell and maintain light-emissions of discharge cells.

The scan electrode 102 and the sustain electrode 103 are covered with one or more upper dielectric layers 104 for limiting a discharge current and providing insulation between the maintenance electrode pairs. A protective layer 105 with a deposit of MgO is formed on an upper surface of the upper dielectric layer 104 to facilitate discharge conditions.

A plurality of stripe-type (or well-type) barrier ribs 112 are formed in parallel on a rear glass substrate 111 of the rear panel 110 to form a plurality of discharge spaces, that is, a plurality of discharge cells.

A plurality of address electrodes 113 are arranged in parallel with the barrier ribs 112 to perform an address discharge and generate vacuum ultraviolet rays. Red (R), green (G) and blue (B) phosphors 114 are coated an upper surface of the rear glass substrate 111 to emit visible light for displaying an image during the generation of the address discharge. A lower dielectric layer 115 is formed between the address electrodes 113 and the phosphors 114 to protect the address electrodes 113.

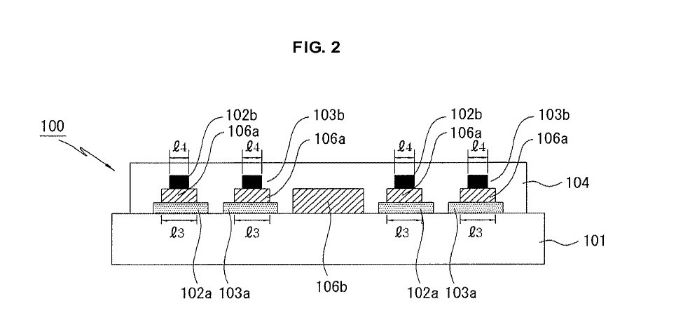

FIG. 2 is a schematic cross-sectional view of a front panel of the plasma display panel according to the first embodiment of the present invention.

As shown in FIG. 2, the plurality of maintenance electrode pairs are arranged in parallel on the front glass substrate 101 of the front panel 100. The maintenance electrode pair comprise the transparent electrodes 102a and 103a made of transparent ITO material and the bus electrodes 102b and 103b made of a metal material such as Ag on the transparent electrodes 102a and 103a.

Black layers 106a and 106b made of an electrically conductive material each are formed between the transparent electrodes 102a and 103a and the bus electrodes 102b and 103b. The Black layers 106a and 106b perform a light blocking function for reducing reflectivity by absorbing external light generated from the outside of the front glass substrate 101, and improve color purity and contrast of the front glass substrate 101.

The width of the black layers 106a and 106b formed between the transparent electrodes 102a and 103a and the bus electrodes 102b and 103b is more than the width of the bus electrodes 102b and 103b formed thereon. Thus, black luminance decreases and the contrast improves.

Contrast being an important factor for evaluating the image quality of the plasma display panel is proportional to white peak and is inversely proportional to black luminance. After all, an increase in the black luminance reduces contrast. The white peak is referred to as a state of the brightest screen in an area below 10% on the basis of the area below 10% of the entire screen of the plasma display panel. The black luminance is referred to as a state in which data input is 0, that is, the luminance of the plasma display panel in its minimum luminance state.

Therefore, an increase in the area of the black layers 106a and 106b reduces the black luminance within the range capable of securing aperture ratio, and a reduction in the black luminance improves contrast.

Accordingly, the width of the black layers 106a and 106b of the plasma display panel according to the first embodiment of the present invention is more than the width of the bus electrodes 102b and 103b. For this, the width of the black layers 106a and 106b may be more than the width of the related art black layer. Or, the width of the bus electrodes 102b and 103b may be less than the width of the related art bus electrode. Or, the width of the black layers 106a and 106b may increase and the width of the bus electrodes 102b and 103b may decrease.

In FIG. 2, l3 denotes the width of the black layer 106a, and l4 denotes the width of the bus electrodes 102b and 103b. Since the width l4 of the bus electrodes 102b and 103b is less than the width l3 of the black layer 106a, the black luminance decreases by an increase in the area of the black layers 106a and 106b and contrast is improved.

Since the width of the black layers 106a and 106b formed under the bus electrodes 102b and 103b is more than the width of the bus electrodes 102b and 103b, edge curl is prevented in edges of the bus electrodes 102b and 103b.

It is preferable that the bus electrodes 102b and 103b are formed in the middle of the black layers 106a and 106b.

It is preferable that the width l3 of the black layers 106a and 106b ranges from 20 μm to 100 μm in consideration of the security of aperture ratio or resistances of the bus electrodes 102b and 103b. More preferably, the width l3 of the black layers 106a and 106b ranges from 50 μm to 80 μm.

It is preferable that the width of the bus electrodes 102b and 103b ranges from 50% to 90% of the width of the black layers 106a and 106b. When the width of the bus electrodes 102b and 103b ranges from 50% to 90% of the width of the black layers 106a and 106b, it is more preferable that a value subtracting the width of the bus electrodes 102b and 103b from the width of the black layer 106a and 106b is less than 20 μm.

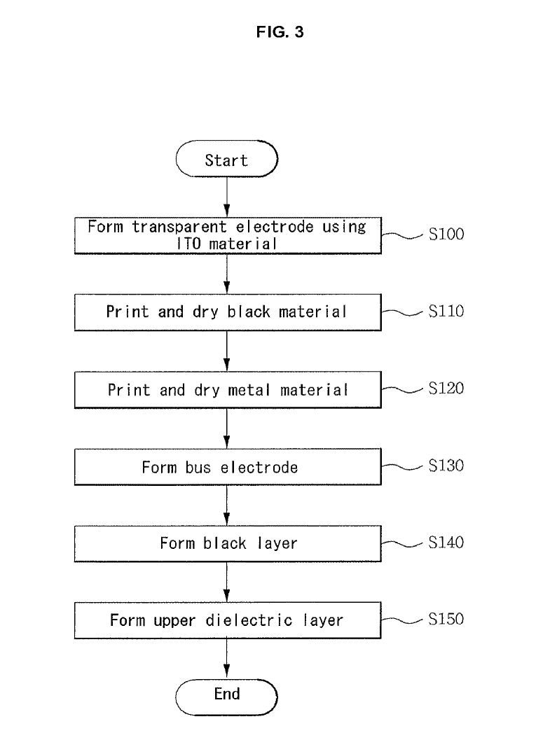

FIG. 3 is a flowchart of a method of manufacturing the front panel of the plasma display panel according to the first embodiment of the present invention.

In step S100, ITO electrode patterns of the transparent electrodes 102a and 103a are formed on the front glass substrate 101 using ITO material.

In step S110, a black material such as a black paste is printed and dried to cover the ITO electrode patterns.

In step S120, a metal material such as a silver paste is printed and dried on an upper part of the black material.

In step S130, the metal material is exposed and developed using a first mask, thereby forming the bus electrodes 102b and 103b. Then, the bus electrodes 102b and 103b are dried and fired.

In step S140, the black material is exposed and developed using a second mask, and then the black layers 106a and 106b of the width more than the width of the bus electrodes 102b and 103b are formed on lower parts of the bus electrodes 102b and 103b.

In step S150, a dielectric material is printed and dried on an upper part of the front glass substrate 101 to cover the transparent electrodes 102a and 103a, the black layer 106a, the bus electrodes 102b and 103b and the black layer 106b protruded from the front glass substrate 101. Then, the upper dielectric layer 104 is formed.

The first mask and the second mask are used to manufacture the plasma display panel in FIG. 3. However, an additional mask may be used to manufacture the plasma display panel.

FIG. 4 is a schematic cross-sectional view of a front panel of a plasma display panel according to a second embodiment of the present invention.

As shown in FIG. 4, a plurality of maintenance electrode pairs are arranged in parallel on a front glass substrate 401 of a front panel 400. The maintenance electrode pair comprise transparent electrodes 402a and 403a made of ITO material and bus electrodes 402b and 403b made of a metal material such as Ag on the transparent electrodes 402a and 403a.

Black layers 406a and 406b made of an electrically conductive material each are formed between the transparent electrodes 402a and 403a and the bus electrodes 402b and 403b.

The Black layer 406a and 406b are formed to be extended from a non-discharge region between discharge cells to a region between the transparent electrodes 402a and 403a and the bus electrodes 402b and 403b of a discharge cell adjacent to the non-discharge region. The Black layers 406a and 406b perform a light blocking function for reducing reflectivity by absorbing external light generated from the outside of the front glass substrate 401, and improve color purity and contrast of the front glass substrate 401.

Unlike the front panel 100 according to the first embodiment of the present invention, the Black layers 406a and 406b according to the second embodiment of the present invention are formed by a single process. Accordingly, a manufacturing process of the front panel 400 is simpler than the front panel 100, thereby reducing the manufacturing cost of the plasma display panel.

A width l3 of the black layer 406a on the transparent electrodes 402a and 403a is more than a width l4 of the bus electrodes 402b and 403b on the black layer 406a. Thus, black luminance is reduced and contrast is improved by a reduction in the black luminance.

Contrast being an important factor for evaluating the image quality of the plasma display panel is proportional to white peak and is inversely proportional to black luminance. After all, an increase in the black luminance reduces contrast.

Therefore, an increase in the area of the black layer 406a reduces the black luminance within the range capable of securing aperture ratio, and a reduction in the black luminance improves contrast.

Accordingly, the width l3 of the black layer 406a on the transparent electrodes 402a and 403a in the plasma display panel according to the second embodiment of the present invention is more than the width l4 of the bus electrodes 402b and 403b thereon. For this, the width l3 of the black layer 406a may be more than the width of the related art black layer. Or, the width l4 of the bus electrodes 402b and 403b may be less than the width of the related art bus electrode. Or, the width l3 of the black layer 406a may increase and the width l4 of the bus electrodes 102b and 103b may decrease.

As described above, since the width l4 of the bus electrodes 402b and 403b is less than the width l3 of the black layer 406a on the transparent electrodes 402a and 403a, the black luminance decreases by an increase in the area of the black layer 406a and contrast is improved.

Since the width of the black layer 406a on the transparent electrodes 402a and 403a is more than the width of the bus electrodes 402b and 403b, edge curl is prevented in edges of the bus electrodes 402b and 403b.

It is preferable that the bus electrodes 402b and 403b are formed in the middle of the black layer 406a on the transparent electrodes 402a and 403a.

It is preferable that the width l3 of the black layer 406a on the transparent electrodes 402a and 403a ranges from 20 μm to 100 μm in consideration of the security of aperture ratio or resistances of the bus electrodes 402b and 403b. More preferably, the width l3 of the black layer 406a on the transparent electrodes 402a and 403a ranges from 50 μm to 80 μm.

It is preferable that the width of the bus electrodes 402b and 403b ranges from 50% to 90% of the width of the black layer 406a on the transparent electrodes 402a and 403a. When the width of the bus electrodes 402b and 403b ranges from 50% to 90% of the width of the black layer 406a, it is more preferable that a value subtracting the width of the bus electrodes 402b and 403b from the width of the black layer 406a on the transparent electrodes 402a and 403a is less than 20 μm.

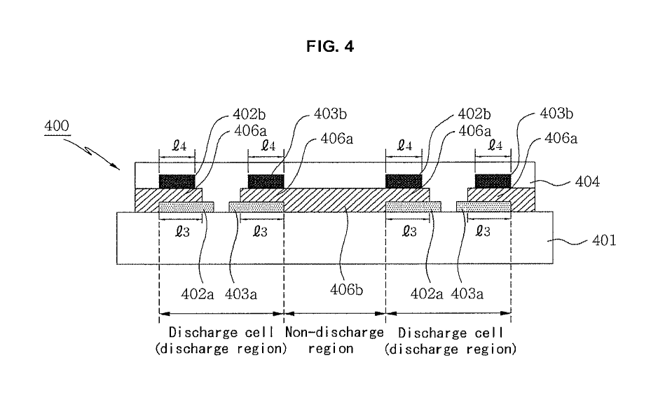

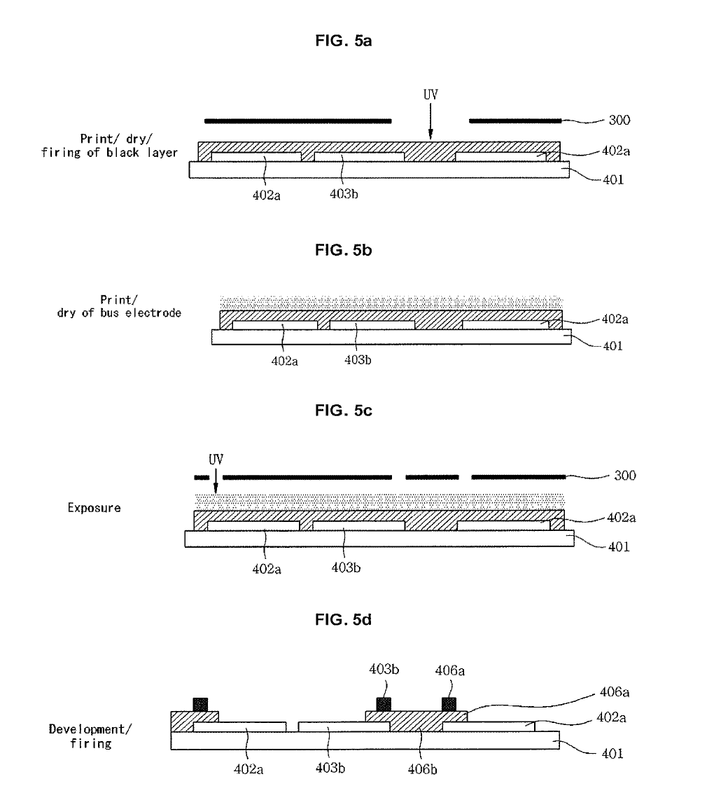

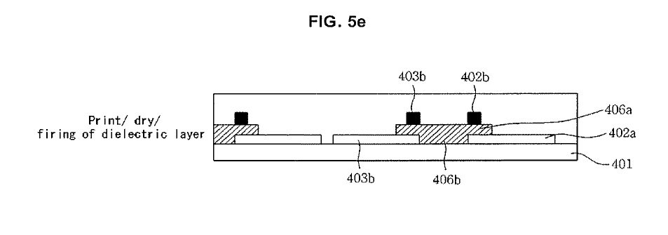

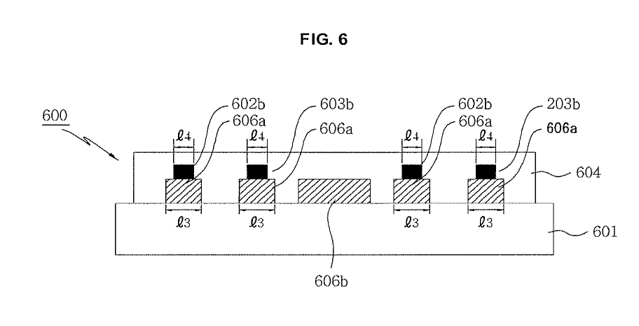

FIGS. 5a through 5e are cross-sectional views sequentially illustrating each of stages in a method of manufacturing the front panel of the plasma display panel according to the second embodiment of the present invention.

As shown in FIG. 5a, ITO electrode patterns of the transparent electrodes 402a and 403a are formed on the front glass substrate 401 using ITO material. Next, a black material such as a black paste for forming the black layers 406a and 406b is printed and dried, and then formation portions of the black layers 406 and 406b shown in FIG. 4 are exposed using a first mask.

As shown in FIG. 5b, a metal material such as a silver paste for forming the bus electrodes 402b and 403b is printed and dried on the black material.

As shown in FIGS. 5c and 5d, formation portions of the bus electrodes 402b and 403b are exposed and developed by ultraviolet rays using a second mask, and then are fired using a firing furnace (not shown).

As shown in FIG. 5e, a dielectric paste is printed and dried. Then, the dielectric paste is fired.

The first mask and the second mask are used to manufacture the plasma display panel in FIG. 5. However, an additional mask may be used to manufacture the plasma display panel.

FIG. 6 is a schematic cross-sectional view of a front panel of a plasma display panel according to a third embodiment of the present invention.

As shown in FIG. 6, a plurality of maintenance electrode pairs comprising bus electrodes 602b and 603b made of a metal material such as Ag are arranged in parallel on a front glass substrate 601 of a front panel 600.

Since an expensive transparent electrode is not formed on the front panel 600 of the plasma display panel according to the third embodiment of the present invention unlike the front panel 100 of the plasma display panel according to the first embodiment of the present invention, the manufacturing cost of the plasma display panel decreases.

Black layers 606a and 606b made of an electrically conductive material are formed on the front glass substrate 601 of the front panel 600. The Black layers 606a and 606b perform a light blocking function for reducing reflectivity by absorbing external light generated from the outside of the front glass substrate 601, and improve color purity and contrast of the front glass substrate 601.

The width of the black layers 606a and 606b under the bus electrodes 602b and 603b is more than the width of the bus electrodes 602b and 603b. Thus, black luminance is reduced and contrast is improved by a reduction in the black luminance.

Contrast being an important factor for evaluating the image quality of the plasma display panel is proportional to white peak and is inversely proportional to black luminance. After all, an increase in the black luminance reduces contrast.

Therefore, an increase in the areas of the black layers 606a and 606b reduces the black luminance within the range capable of securing aperture ratio, and a reduction in the black luminance improves contrast.

Accordingly, the width of the black layers 606a and 606b in the plasma display panel according to the third embodiment of the present invention is more than the width of the bus electrodes 602b and 603b thereon. For this, the width of the black layer 606a and 606b may be more than the width of the related art black layer. Or, the width of the bus electrodes 602b and 603b may be less than the width of the related art bus electrode. Or, the width of the black layers 606a and 606b may increase and the width of the bus electrodes 602b and 603b may decrease.

In FIG. 6, l3 denotes the width of the black layers 606a and 606b, and l4 denotes the width of the bus electrodes 602b and 603b. Since the width l4 of the bus electrodes 602b and 603b is less than the width l3 of the black layer 606a and 606b, the black luminance decreases by an increase in the area of the black layers 606a and 606b and contrast is improved.

Since the width of the black layers 606a and 606b formed under the bus electrodes 602b and 603b is more than the width of the bus electrodes 402b and 403b, edge curl is prevented in edges of the bus electrodes 602b and 603b.

It is preferable that the bus electrodes 602b and 603b are formed in the middle of the black layers 606a and 606b.

It is preferable that the width l3 of the black layers 606a and 606b ranges from 20 μm to 100 μm in consideration of the security of aperture ratio or resistances of the bus electrodes 602b and 603b. More preferably, the width l3 of the black layers 606a and 606b ranges from 50 μm to 80 μm.

It is preferable that the width of the bus electrodes 602b and 603b ranges from 50% to 90% of the width of the black layers 606a and 606b. When the width of the bus electrodes 602b and 603b ranges from 50% to 90% of the width of the black layers 606a and 606b, it is more preferable that a value subtracting the width of the bus electrodes 602b and 603b from the width of the black layers 606a and 606b is less than 20 μm.

As described above, since the width of the bus electrode is less than the width of the black layer in the embodiments of the present invention, the edge curl is prevented and wall charges are uniformly accumulated. Further, contrast is improved by reducing black luminance.

Moreover, a manufacturing process of the plasma display panel according to the embodiments of the present invention is simple, and thus the manufacturing cost of the plasma display panel decreases.

The invention being thus described may be varied in many ways. Such variations are not to be regarded as a departure from the spirit and scope of the invention, and all such modifications as would be obvious to one skilled in the art are intended to be included within the scope of the following claims.

What is claimed is:

1. A plasma display panel comprising:
a front glass substrate;
a transparent electrode formed on the front glass substrate;
a black layer formed on an upper part of the transparent electrode; and
a bus electrode of the width less than the width of the black layer formed on an upper part of the black layer.

2. The plasma display panel of claim 1, wherein the bus electrode is formed in the middle of the black layer.

3. The plasma display panel of claim 1, wherein the width of the black layer ranges from 20 μm to 100 μm.

4. The plasma display panel of claim 3, wherein the width of the black layer ranges from 50 μm to 80 μm.

5. The plasma display panel of claim 1, wherein the width of the bus electrode ranges from 50% to 90% of the width of the black layer.

6. The plasma display panel of claim 5, wherein the difference between the width of the black layer and the width of the bus electrode is less than 20 μm.

7. A plasma display panel comprising:
a front glass substrate;
a transparent electrode formed on the front glass substrate;
a black layer formed on an upper part of the transparent electrode and a non-discharge region between discharge cells; and
a bus electrode of the width less than the width of the black layer formed on an upper part of the black layer on the transparent electrode.

8. The plasma display panel of claim 7, wherein the bus electrode is formed in the middle of the black layer on the transparent electrode.

9. The plasma display panel of claim 7, wherein the width of the black layer on the transparent electrode ranges from 20 μm to 100 μm.

10. The plasma display panel of claim 9, wherein the width of the black layer on the transparent electrode ranges from 50 μm to 80 μm.

11. The plasma display panel of claim 7, wherein the width of the bus electrode ranges from 50% to 90% of the width of the black layer on the transparent electrode.

12. The plasma display panel of claim 11, wherein the difference between the width of the black layer on the transparent electrode and the width of the bus electrode is less than 20 μm.

13. A plasma display panel comprising:
a front glass substrate;
a black layer formed on the front glass substrate; and
a bus electrode of the width less than the width of the black layer formed on an upper part of the black layer.

14. The plasma display panel of claim 13, wherein the bus electrode is formed in the middle of the black layer.

15. The plasma display panel of claim 13, wherein the width of the black layer ranges from 20 μm to 100 μm.

16. The plasma display panel of claim 15, wherein the width of the black layer ranges from 50 μm to 80 μm.

17. The plasma display panel of claim 13, wherein the width of the bus electrode ranges from 50% to 90% of the width of the black layer.

18. The plasma display panel of claim 17, wherein the difference between the width of the black layer and the width of the bus electrode is less than 20 μm.
